(19) United States
(12) Patent Application Publication
(10) Pub. No.: US 2026/0334380 A1
(43) Pub. Date: Oct. 29, 2026

(54) Sky Forest

(71) Applicant: Sandra M. Shinabarger, Virginia Beach, VA (US)

(72) Inventor: Sandra M. Shinabarger, Virginia Beach, VA (US)

(21) Appl. No.: 19/531,573

(22) Filed: Feb. 5, 2026

(51) Int. Cl. A01G 9/033; A01G 9/28

(52) U.S. Cl. CPC A01G 9/033; A01G 9/28

(57) ABSTRACT

This invention supports reducing urban heat and restoring ecological balance in paved developed environments by enabling elevated vegetation in areas otherwise lacking soil or green space. This invention is a system for growing trees (105) or shrubs on building rooftops, comprising a raised garden box (101) supported by weight-bearing pillars (102) configured to carry the load of soil, water, trees, and other vegetation. The system does not impose weight strain on the building, as structural loads are transferred to the ground through the pillars (102). Minimal tension is applied to the building via attached stabilization cables (106) rather than weight.

The height of the system may be modified to enable installation adjacent to a building, in parking lots above parking spaces without occupying those spaces, or as a carport-style variation designed to support shrubs or smaller plants. This relates to urban sustainability and climate change resilience.

### CROSS-REFERENCE TO RELATED APPLICATIONS

This invention relates to urban reforestation, mitigation of urban heat islands, rooftop gardens, raised garden-bed systems, scaffolding structures, forestry applications, tree cultivation, urban agriculture, urban beautification, pergola structures, rooftop utilization, urban air-quality improvement, rebalancing ecological features, and climate-change resilience. This invention is a system for growing trees on building rooftops, enabling the placement of vegetation in urban and suburban environments where soil and open ground are limited. The system supports elevated tree or shrub growth while preventing the structural load from being transferred to the building. More specifically, the invention provides a structural system for supporting elevated vegetation in dense urban and suburban environments paved with concrete and asphalt.

The invention includes weight-bearing pillars (102) configured to support the substantial load of soil, water, tree roots, and maturing trees, thereby enabling rooftop tree growth without transferring significant weight or strain to the underlying building.

### PRIOR ART

References Cited

US 2023 0111009A1
US 2022/0159916 A1
U.S. Pat. No. 8,607,512 B2
U.S. Pat. No. 8,393,439 B2
U.S. Pat. No. 10, 145,103 B
U.S. Pat. No. 7,159,358 B2
U.S. Pat. No. 8,590,190 B2
US D948,972 S
U.S. Pat. No. 12,207,606 B2
JP H06 - 36677
JP 2005 341869A
JP 3328813
CN 214696501

### BACKGROUND OF THE INVENTION

This invention relates generally to urban reforestation, mitigation of urban heat islands, improved urban air quality, urban food security, rooftop gardens, raised garden beds, scaffolding, urban agriculture, urban beautification, and climate change resilience. More specifically, the invention provides a system for growing trees and shrubs in urban and suburban settings, including on building rooftops, parking lots, and other paved environments.

Conventional rooftop garden systems often make roof-top maintenance difficult or inaccessible and place substantial weight and strain on building structures. A major drawback of existing rooftop gardens is that the combined weight of soil, plants, water, and root systems must be borne by the building itself.

This invention overcomes these limitations by providing a weight-bearing, removable structure that transfers the heavy load of soil, water, tree roots, and mature trees onto the invention's own support pillars rather than onto the building. The system is engineered to withstand high winds and may, in certain installations, help shield nearby structures from wind damage or flooding by introducing elevated vegetation and structural buffering.

Urban settings lack sufficient open space for growing trees, and many cities continue to experience declining tree canopy coverage despite ongoing reforestation initiatives. Some metropolitan areas still face persistent smog and degraded air quality, underscoring the need for additional vegetation-based air filtration. One largely untapped spatial resource is the rooftops of buildings, including shopping centers, big box retail stores, small retail stores, apartment complexes, and residential homes. This invention may initially be deployed on buildings under three stories in height to establish feasibility and validate performance in real-world conditions. Early installations on lower-height structures allow for evaluation of wind resistance, load transfer, maintenance access, and ecological impact before scaling the system to taller buildings and more complex urban environments.

Trees provide substantial environmental and public-health benefits: trees enhance air-quality levels, reduce ambient temperatures, conserve energy, and soften the harsh visual impact of concrete-dominated landscapes. Tree-based air filtration can also help reduce the spread of airborne infectious diseases, and exposure to trees is associated with improved mental-health outcomes.

Increasing vegetation on paved urban surfaces can significantly improve stormwater management. Trees and plants absorb rainwater through their roots, branches, and leaves, reducing the volume of water that would otherwise flow across impermeable concrete and contribute to flooding. Expanding vegetation is one of the most effective strategies for mitigating urban heat, reducing stormwater runoff, and countering ecological loss in densely developed areas.

The core principle is to transform hard, impervious surfaces into functional green infrastructure that performs environmental work rather than merely occupying space. By introducing elevated vegetation into paved environments, rainwater can be intercepted and absorbed instead of overwhelming drainage systems. Reducing urban heat through increased vegetation may also help moderate storm intensity, as cooler microclimates can influence localized atmospheric conditions.

This invention contributes to restoring the ecological balance of paved urban landscapes by enabling the placement of trees and other vegetation in areas where soil is unavailable, thereby enhancing stormwater absorption, reducing heat, and improving environmental resilience.

### SUMMARY OF THE INVENTION

The invention is a structural system configured as a variation of a rooftop garden that adds no weight to an existing building structure and applies only minimal tension through optional stabilization cables. The system is weight-bearing, transferring the load of trees, soil, and water to its own independent support members rather than to the building.

The system includes a raised garden bed (101) supported by pillars (102) and stabilizing braces (103), with tubes (104) extending through the garden bed (101) to improve wind resistance. The garden bed may operate as a self-watering unit when plant roots reach the lower water-retention tray. Optional components include a net (206) rain-barrel attachment (204), flagpole holders (201), banner holders (202), and hooks for hanging baskets (203). A net (206) may be positioned around a tree (105) to intercept debris, preventing branches or other materials from falling to the ground and reducing the risk of injury from falling debris.

The invention supports reducing urban heat island effects, improving air quality, and increasing photosynthetic capacity in dense urban environments. By enabling rooftop vegetation, the system provides a means of reforestation and ecological restoration in developed areas. The height and size of the structure may be modified for installation in parking lots, sidewalks, or as a carport-style configuration, thereby utilizing paved surfaces without occupying parking spaces.

### BRIEF DESCRIPTION OF DRAWINGS

FIG. 1 is a drawing of four pillars or poles (102) supporting a raised garden box (101). The garden box to grow trees (101) does not touch the building and it is placed diagonally across one corner of a flat roof top. Cables (106) are anchored to the building roof top to stabilize the structure and trees (105) from wind. The garden box (101) has tubes (104) through it for wind resistance.

FIG. 2 is a modified expanded version of FIG. 1 with six pillars (102).

FIG. 3 is a side view of FIG. 1 that depicts various options such as signage (202), a flagpole holder (201), flower basket holder (203), and a rain barrel (204).

FIG. 4 is a modification of FIG. 1 to fit a sidewalk that is next to a building.

FIG. 5 is a modification of FIG. 4 to fit over four parking spaces in a parking lot.

FIG. 6 is an expanded modification of FIG. 5 to fit over twelve parking spaces in a parking lot.

FIG. 7 depicts the base of the structure in FIG. 1.

FIG. 8 illustrates the inner core of the base of the structure in FIG. 1.

FIG. 9 is a tube through the garden box for wind resistance.

FIG. 10 is a sloped roof version of FIG. 1.

### DETAILED DESCRIPTION OF THE INVENTION

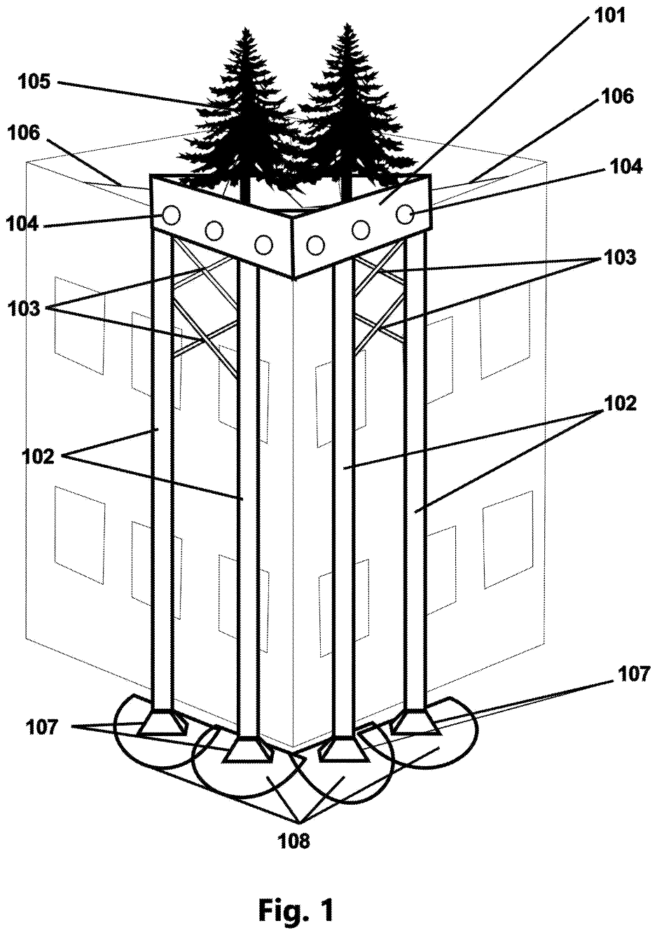

FIG. 1 shows an embodiment comprising four poles or pillars (102) supporting a raised garden box (101) designed to grow trees (105). The garden box (101) is positioned diagonally across one corner of a flat rooftop, such as the roof of a large retail store, and does not contact the building structure. The garden box (101) is formed in a triangular shape to fit the rooftop corner geometry.

The bottom of the garden box (101) is arched to distribute weight efficiently onto the supporting pillars (102). Wind-resistance tubes (104) extend through the middle of the garden box to reduce lateral wind loading on the structure and the trees. Support bars (103) brace the pillars (102) to provide additional stability.

Cables (106) are anchored from the tree (105) to the garden box (101), and from the garden box (101) to the building roof, to stabilize both the vegetation and the structure under wind forces. A sturdy base (107) and an extended base (108) at ground level support the pillars (102), the garden box (101), the soil, and the trees (105), ensuring proper load transfer and overall structural integrity. Drawings in FIGS. 1-10 are not drawn to scale.

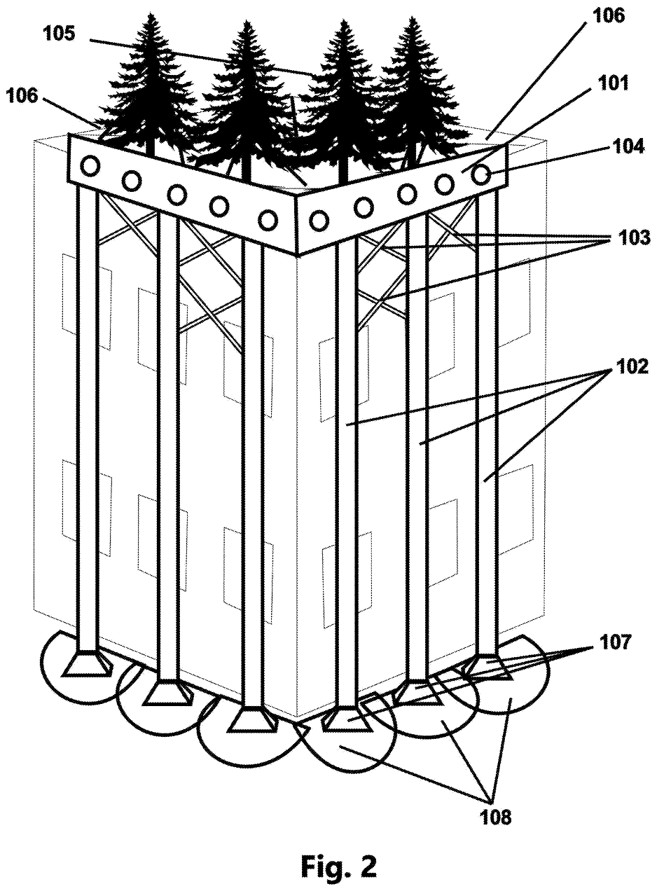

FIG. 2 is a modified expanded version of FIG. 1. FIG. 2 depicts an extended embodiment relative to FIG. 1, incorporating six support pillars (102) to accommodate a larger raised garden box (101) and increased load-bearing capacity. Six supporting poles (102) and six bases (107) and (108) for the garden box (101) and twelve supporting bars (103) are featured in FIG. 2. FIG. 2 has six pillars (102) and FIG. 1 has four. FIG. 2 implements ten wind-resistance tubes (104) extending through the garden box (101). The embodiment further integrates the same stabilizing cable system (106) to support the trees (105) and maintain structural stability of the garden boxes (101). The six pillars in FIG. 2 correspond to the same number four pillars in FIG. 1, and each pillar's position and spacing are scaled. The distances between corresponding points such as pillar centers (102) in FIG. 2 are proportional to those in FIG. 1.

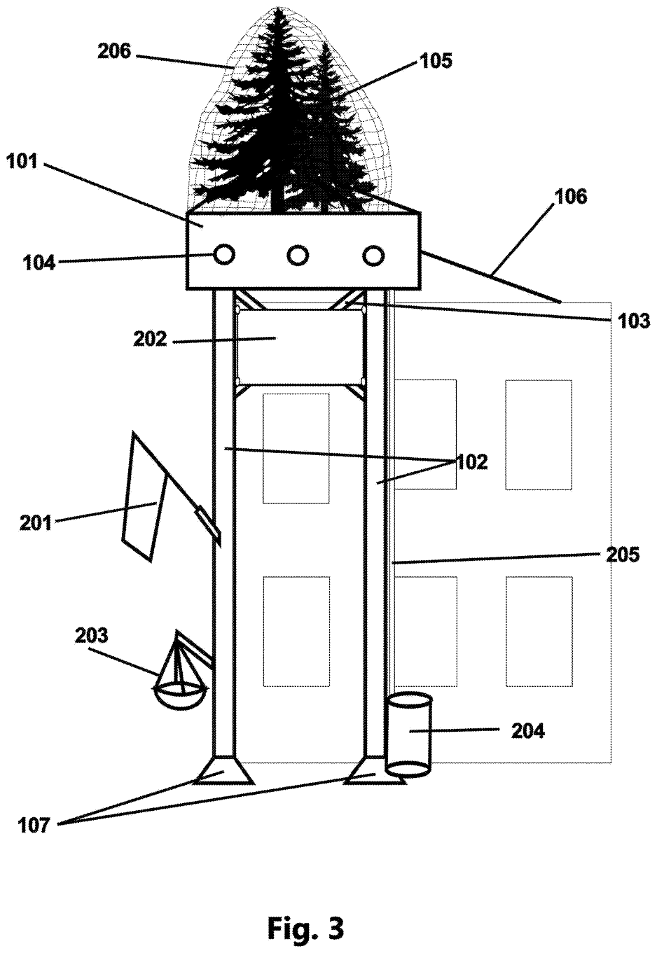

FIG. 3 shows a side-view of the raised vegetation platform and highlights several optional components that may be included in any embodiment of the invention. FIG. 3 depicts well-established preexisting items that could be added based on preferences. The garden box (101) for trees drains into an optional rain barrel (204) located on the ground as shown in FIG. 3 or drains onto the ground. A drainage gutter (205) is attached behind one of the pillars (102). An optional cover (202) over the support bars (103) for aesthetic or advertising purposes, is shown in FIG. 3. The poles can also have a modification to allow for hanging plant baskets (203) and flags (201). Depending on the plants chosen, a net (206) may be positioned around the tree (105) to intercept and contain debris that may detach from the tree, thereby preventing such debris from falling to the ground and preventing potential and unlikely injuries.

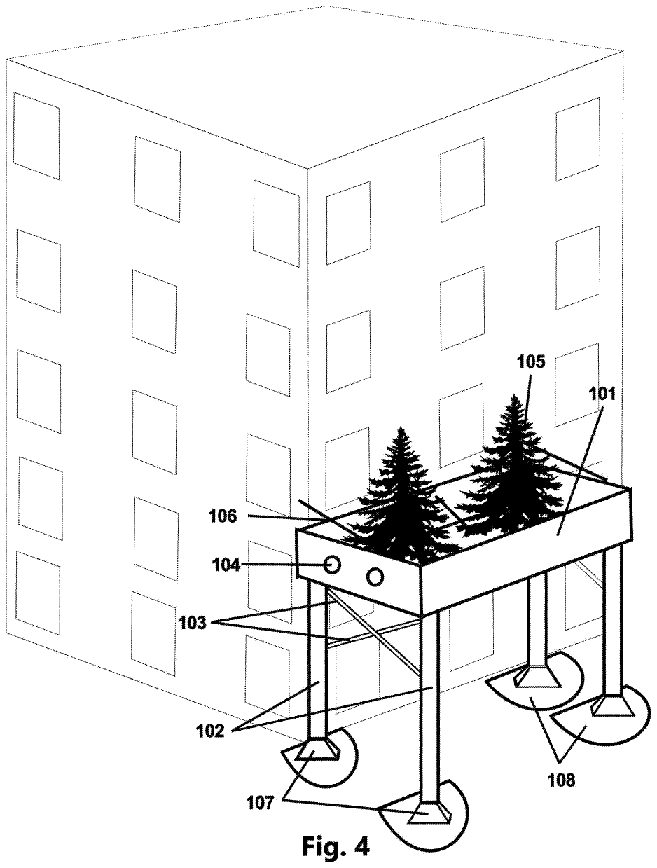

FIG. 4 depicts an embodiment adapted for installation on a sidewalk. In this configuration, the raised garden box (101) and support pillars (102) are dimensioned and arranged to fit within typical sidewalk widths while maintaining pedestrian clearance. FIG. 4 is a modification of FIG. 1 where the garden box (101) in FIG. 4 is a rectangular shape with two wind resistance tubes (104) and the four pillars (102) are shorter in length. The structure remains independent of adjacent buildings, with its weight borne by the support pillars (102) rather than nearby architecture. Stabilizing components, such as cables (106), braces (103), or optional accessories, are included as appropriate for the installation environment. Pillars (102) are supported by a base (107) and extended base (108). For areas that are prone to earthquakes, pillars (102) or poles can be modified with flexible sturdy materials for earthquake resistance.

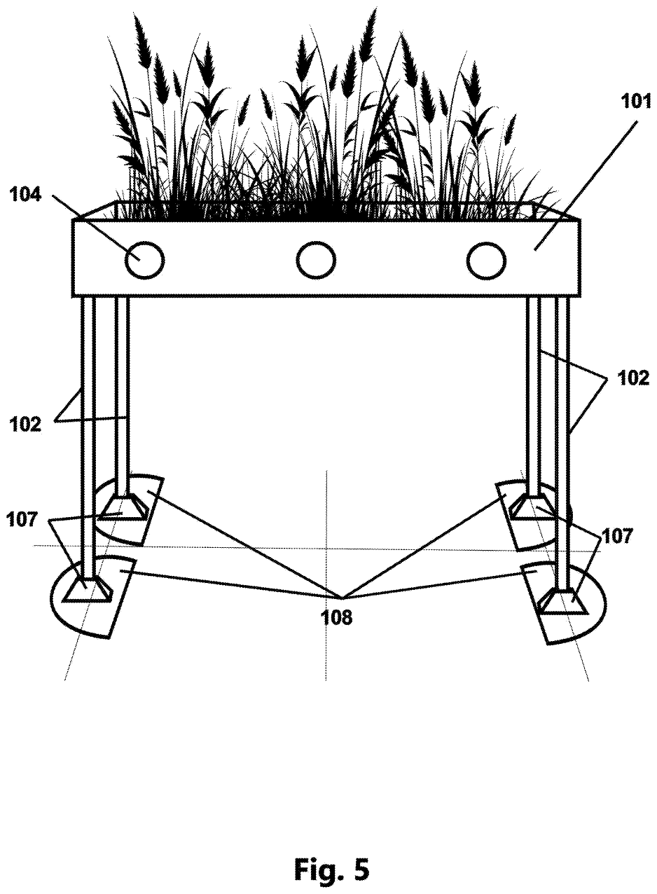

FIG. 5 illustrates an embodiment adapted for installation within a parking lot or driveway as a carport or pergola style structure. In this configuration, the raised garden box (101) and its support system are dimensioned to fit within standard parking-space widths and drive-aisle clearances. The support pillars (102) elevate the vegetation platform (101) above vehicle height, allowing cars to park or pass underneath without interference. Garden boxes (101) can function in parking lots without taking up any parking spaces. As in the primary embodiment of FIG. 1, the structure remains freestanding, with its weight borne by the support pillars (102) and on the parking surface but not on any adjacent architecture. Wind-resistance tubes (104) are included as a stabilizing component. Optional stabilizing components shown in FIG. 3, such as cables (106), braces (103), or nets (206), may be added this pergola style or carport style variation shown in FIG. 5 depending on site conditions.

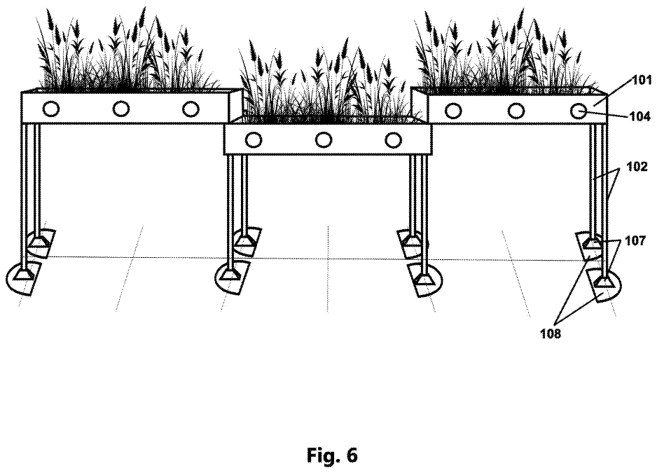

FIG. 6 illustrates an expanded version of the parking lot or carport modification shown in FIG. 5. In this embodiment, the raised garden box (101) spans a larger horizontal area, supported by an increased number of pillars (102) to accommodate wider vehicle lanes, multiple parking spaces, or larger carport bays. The elevated vegetation platform maintains full clearance for vehicle movement beneath it while providing increased canopy coverage, greater soil volume, and enhanced stormwater or shading performance. A wind-resistance tube (104) is included as a stabilizing component. Additional stabilizing components such as lateral braces (103), or tension cables (106) shown in FIG. 1 may be incorporated depending on site geometry and environmental loading.

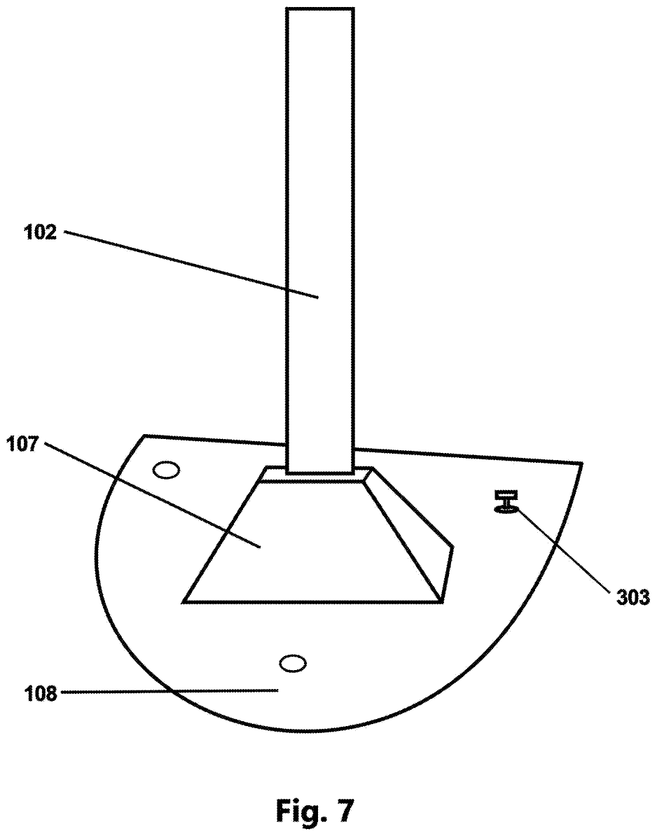

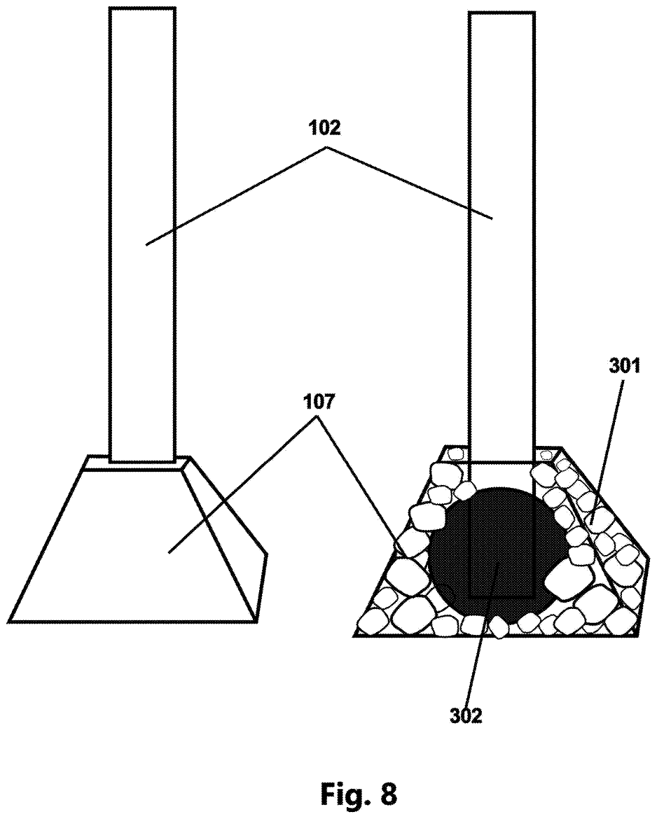

FIG. 7 provides an enlarged view of the base assembly of the structure depicted in FIG. 1, illustrating the configuration of the lower stabilizing members, and associated structural interfaces. The half circle shape is the extended stabilizing base (108). The extended base (108) may include a series of holes, configured to receive bolts (303), permitting the structure to be optionally secured to a concrete surface for enhanced stability. The trapezoid shape (107) has the options to be comprised of solid concrete or may be a hard cover that conceals optional interior components (shown in FIG. 8) and supports the pillar (102).

FIG. 8 is an interior view of the base assembly (107), showing the internal structural configuration of a portable option that supports the raised garden box (101). FIG. 8 illustrates the arrangement of optional portable internal load-bearing interfaces, and internal anchoring or stabilizing components that are not visible from the exterior perspective in FIG. 7. The bases (107) of the poles (102) have the options to be solid concrete or may include optional wheels (302) that lock, depending on the environment or building maintenance needs where the structure is better suited to be portable. Rocks (301) of manageable sizes, approximately 4 to 10 inches in length, are placed over the wheels (302) to provide stability for the invention structure. A hard cover (107) conceals the rocks (301) and wheels (302) with a lock on it, shown in FIG. 8. For added stability there is an extended base (108) shown in FIG. 7 of flat possibly wrought iron or other sturdy material of at least 2-5 feet in diameter, depending on the version of the entire structure. The bases can be buried underground or can rest on top of concrete or may be bolted into concrete.

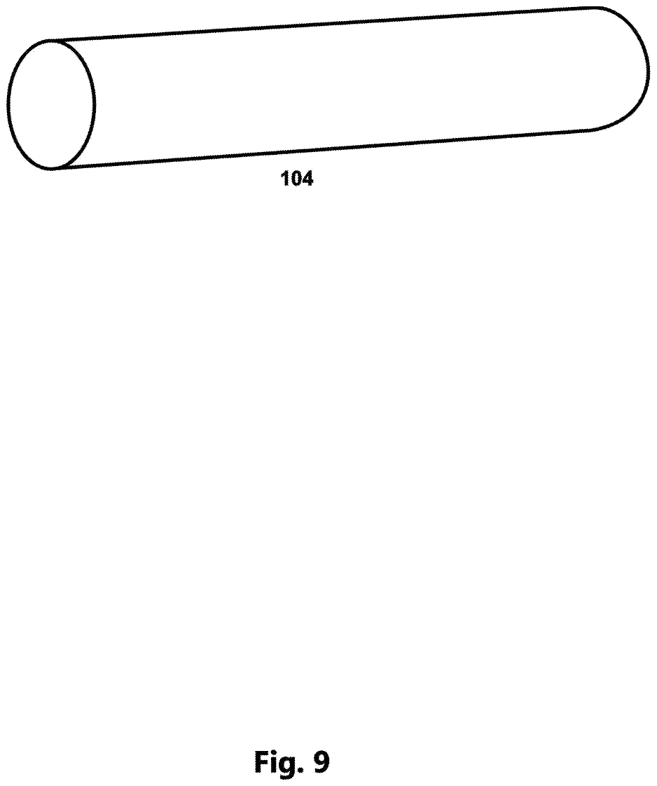

FIG. 9 presents an enlarged view of the tube (104) extending through the garden box (101). The tube's function is a wind-resistance element in the embodiments depicted in FIGS. 1-6 and FIG. 10.

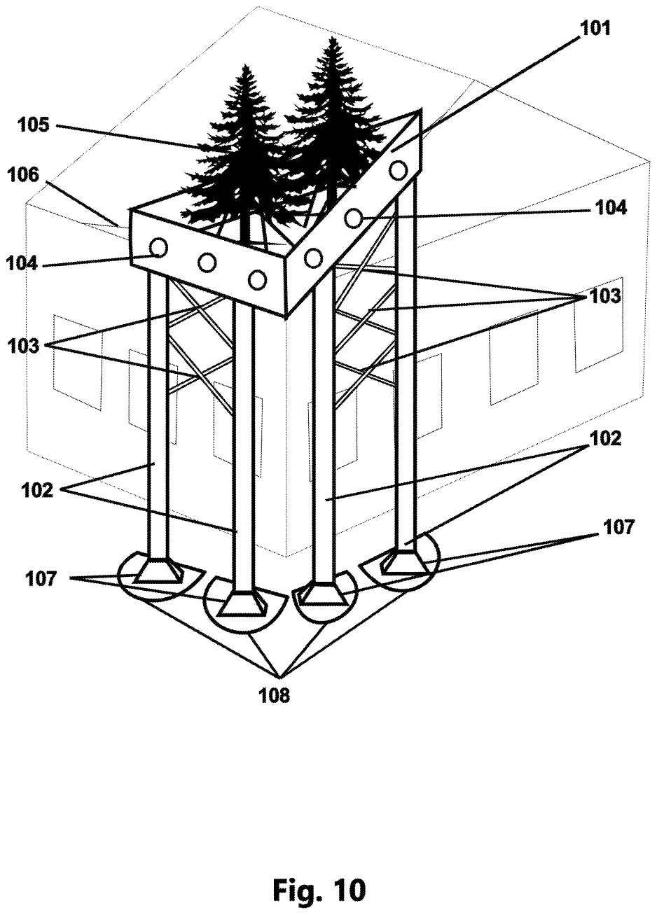

FIG. 10 is a modified version of FIG. 1 for sloped roof tops. The corresponding labels are the same as FIG. 1. FIG. 1 depicts the structure installed on a flat roof surface, such as a big box retail store. FIG. 10 presents an alternative embodiment adapted for use on a sloped roof, showing the modifications necessary to accommodate roof pitch. The garden box (101), the poles (102), the bases (107) and (108), support bars (103), tubes for wind resistance are (104), cables for stability are (106), and trees (105) are mostly the same except two of the pillars (102) are longer than the other two pillars (102) and there are two additional support braces (103).

1. A weight-bearing structure comprising of at least four weight-bearing pillars (102), each configured to transfer the load of the raised garden box (101), soil, water, and vegetation to the ground.

2. The weight bearing structure of claim 1, further comprising one or more additional pillars (102) configured to increase load-bearing capacity for expanded installations.

3. The weight-bearing structure of claim 1, further comprising one or more cables (106) anchored between a tree (105), the raised garden box (101), and a building surface, wherein the cables are configured to provide stabilizing tension while imposing substantially no vertical structural load on the building surface.

4. The weight-bearing structure of claim 1, wherein the structure is configured to support elevated vegetation for mitigating heat associated with urban or suburban paved surfaces.

5. The weight-bearing structure of claim 1, further comprising wheels (302) positioned at or concealed within a base (107) of the pillars (102), the wheels being configured to facilitate relocation of the structure.

6. The weight-bearing structure of claim 1, further comprising one or more tubes (104) extending through the raised garden box (101), the tubes being configured to reduce lateral wind forces acting on the structure.

7. The weight-bearing structure of claim 1, further comprising a cover (202) positioned above one or more cross-bar braces (103).

8. The weight-bearing structure of claim 7, wherein the cover (202) is configured to protect structural components positioned beneath the cover and optionally provide a display surface for optional signage.

9. The weight-bearing structure of claim 1, further comprising one or more accessories selected from the group of well-established preexisting items consisting of: a rain barrel attachment (204); a flagpole holder (201); a hanging basket hook (203), and other watering aids.

10. The weight-bearing structure of claim 1, further comprising a safety net (206) positioned around a tree (105), the safety net being configured to intercept falling branches or debris.

11. The weight-bearing structure of claim 1, wherein the height of the structure is adjustable to accommodate installation in parking lots, carports, sidewalks, or other locations requiring vehicle or pedestrian clearance.

12. The weight-bearing structure of claim 1, wherein the pillars (102), anchoring configurations, or load-distribution components are dimensioned to permit installation on commercial buildings, residential buildings, parking lots, driveways, sidewalks, or multi-story structures.

13. The weight-bearing structure of claim 1, wherein the structure comprises a collective combination of preexisting structural and horticultural components arranged to support elevated vegetation.

14. Taken collectively, the features described in claims 1-13 herein are not found or disclosed in the prior art and these features may alter the outward appearance of a building without imposing significant structural load on the building itself.
